(19) United States
(12) Patent Application Publication
(10) Pub. No.: US 2024/0212494 A1
(43) Pub. Date: Jun. 27, 2024

(54) INFORMATION PROCESSING DEVICE, CONTROL SYSTEM, AND CONTROL METHOD

(71) Applicant: Mitsubishi Electric Corporation, Tokyo (JP)

(72) Inventor: Masato TSUCHIYA, Tokyo (JP)

(73) Assignee: Mitsubishi Electric Corporation, Tokyo (JP)

(21) Appl. No.: 18/600,005

(22) Filed: Mar. 8, 2024

Related U.S. Application Data
(63) Continuation of application No. PCT/JP2021/034127, filed on Sep. 16, 2021.

(51) Int. Cl. G08G 1/0967; G08G 1/0968

(52) U.S. Cl. CPC G08G 1/096725; G08G 1/096833

(57) ABSTRACT

A logistics management server includes an acquisition unit that acquires map information, position information on a supply mobile object, position information on a reception mobile object, and delivery position information and a control unit that generates a plurality of route graphs including a plurality of refueling scheduled positions based on the map information, the position information on the supply mobile object, the position information on the reception mobile object, and the delivery position information, determines a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance out of the plurality of route graphs, and generates control information.

### CROSS-REFERENCE TO RELATED APPLICATION

This application is a continuation application of International Application No. PCT/JP2021/034127 having an international filing date of Sep. 16, 2021.

### BACKGROUND OF THE INVENTION

### 1. Field of the Invention

The present disclosure relates to an information processing device, a control system, and a control method.

### 2. Description of the Related Art

A mobile object operates by using fuel. The fuel is supplied to the mobile object to enable the mobile object to operate continuously. For example, in cases where the fuel is gasoline, the mobile object is supplied with the gasoline at a gas station. There has been proposed a system that supplies the fuel held in a certain mobile object to another mobile object (see Patent Reference 1).

Patent Reference 1: Japanese Patent Application Publication No. 2021-72062

Incidentally, there are cases where there exist a supply mobile object and a reception mobile object that execute at least one of delivery of a parcel and pickup of a parcel. It is possible to consider a method of previously setting a supply position where the fuel held in the supply mobile object should be supplied to the reception mobile object and calculating a route regarding the delivery and including the supply position. However, in this method, a travel distance of the supply mobile object and the reception mobile object can become long.

### SUMMARY OF THE INVENTION

An object of the present disclosure is to shorten the travel distance of the supply mobile object and the reception mobile object.

An information processing device according to an aspect of the present disclosure is provided. The information processing device includes an acquisition unit that acquires map information, position information on a supply mobile object as a mobile object that supplies fuel, position information on a reception mobile object as a mobile object that receives the fuel, and delivery position information as information indicating at least one of delivery source position information regarding a parcel and delivery destination position information regarding a parcel and a control unit that generates a plurality of route graphs including a plurality of refueling scheduled positions based on the map information, the position information on the supply mobile object, the position information on the reception mobile object, and the delivery position information, determines a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance, out of the plurality of route graphs, and generates control information, as information for controlling the supply mobile object and the reception mobile object, based on the determined route graph.

According to the present disclosure, the travel distance of the supply mobile object and the reception mobile object can be shortened.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing a control system in a first embodiment;

FIG. 2 is a diagram showing hardware included in a logistics management server in the first embodiment;

FIG. 3 is a block diagram showing functions of a mobile object management server in the first embodiment;

FIG. 4 is a block diagram showing functions of the logistics management server in the first embodiment;

FIGS. 5(A) to 5(E) are diagrams showing an example of a plurality of route graphs in the first embodiment;

FIG. 6 is a diagram showing an example of control information in the first embodiment;

FIG. 7 is an example of a block diagram showing functions of a supply mobile object in the first embodiment;

FIG. 8 is a sequence diagram (No. 1) showing an example of a process executed in the control system in the first embodiment;

FIG. 9 is a sequence diagram (No. 2) showing the example of the process executed in the control system in the first embodiment;

FIG. 10 is a sequence diagram (No. 3) showing the example of the process executed in the control system in the first embodiment;

FIG. 11 is a diagram showing a control system in a second embodiment;

FIGS. 12(A) to 12(E) are diagrams showing an example of the plurality of route graphs in the second embodiment;

FIG. 13 is a diagram showing an example of the control information in the second embodiment; and

FIG. 14 is a diagram showing a control system in a third embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

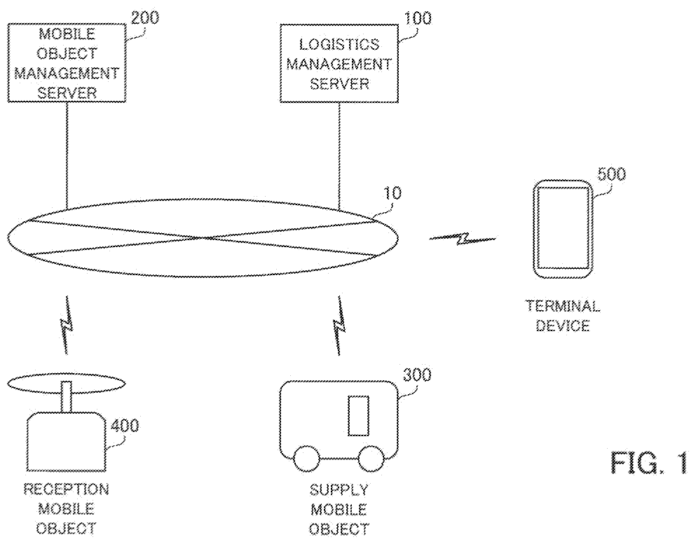

FIG. 1 is a diagram showing a control system in a first embodiment. The control system includes a logistics management server 100, a supply mobile object 300 and a reception mobile object 400. The control system may include a mobile object management server 200 and a terminal device 500.

The logistics management server 100, the mobile object management server 200, the supply mobile object 300, the reception mobile object 400 and the terminal device 500 execute communication via a network 10.

The logistics management server 100 is a device that executes a control method. The logistics management server 100 is referred to also as an information processing device. The logistics management server 100 receives a parcel delivery request from the terminal device 500. For example, the delivery request includes information on the parcel and information on a delivery source, a delivery destination, and so forth. When the delivery request is received, the logistics management server 100 generates control information including information regarding the delivery of the parcel and information regarding the supply (refueling). The logistics management server 100 transmits the control information to the mobile object management server 200.

The mobile object management server 200 manages the supply mobile object 300 and the reception mobile object 400. The mobile object management server 200 controls the supply mobile object 300 and the reception mobile object 400 based on the control information. For example, according to the control, the fuel is supplied from the supply mobile object 300 to the reception mobile object 400.

The supply mobile object 300 and the reception mobile object 400 execute at least one of delivery of a parcel and pickup of a parcel. For example, the supply mobile object 300 delivers a parcel to a delivery destination indicated by a delivery request. For example, the reception mobile object 400 picks up a parcel at a delivery source indicated by a delivery request and delivers the parcel to a delivery destination indicated by the delivery request.

The supply mobile object 300 is a mobile object as an object that supplies the fuel. The supply mobile object 300 is capable of supplying the fuel to the reception mobile object 400. The reception mobile object 400 is a mobile object as an object that receives the fuel. The reception mobile object 400 is capable of receiving the fuel from the supply mobile object 300. Here, each mobile object is, for example, a Personal Mobility Vehicle (PMV), an Autonomous Mobile Robot (AMR), a drone, a ship, or the like. The fuel is, for example, gasoline, electricity, gas, hydrogen, or the like. The fuel can also be a battery.

The method of supplying the fuel from the supply mobile object 300 to the reception mobile object 400 can be either a method of automatically supplying the fuel or a method of manually supplying the fuel. For example, in cases where the fuel is electricity, the supply mobile object 300 supplies the electricity to the reception mobile object 400 by means of noncontact charging. In cases where the fuel is gasoline, the driver of the supply mobile object 300 supplies the gasoline in the supply mobile object 300 to the reception mobile object 400 by a manual operation.

The terminal device 500 is a device used by a user. For example, the terminal device 500 is a smartphone, a tablet terminal or a Personal Computer (PC). The terminal device 500 transmits the delivery request to the logistics management server 100.

FIG. 1 shows one supply mobile object, one reception mobile object and one terminal device. The numbers of supply mobile objects, reception mobile objects and terminal devices are not limited to one.

Next, hardware included in the logistics management server 100 will be described below.

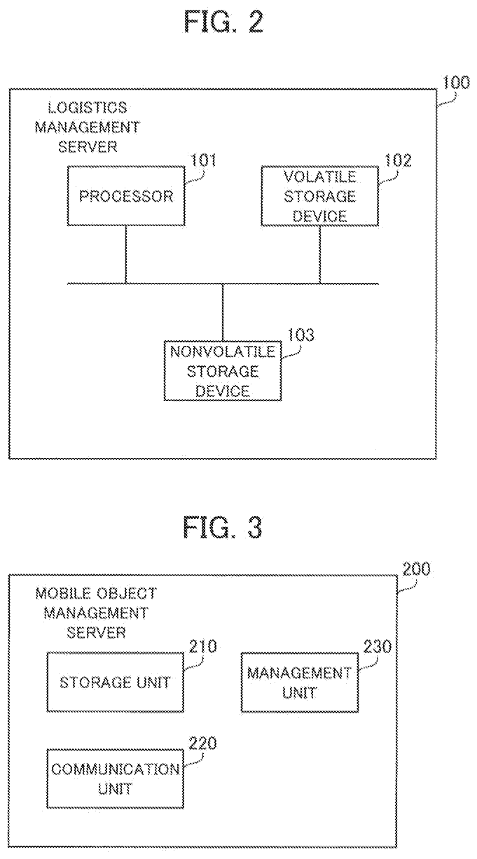

FIG. 2 is a diagram showing the hardware included in the logistics management server in the first embodiment. The logistics management server 100 includes a processor 101, a volatile storage device 102 and a nonvolatile storage device 103.

The processor 101 controls the whole of the logistics management server 100. The processor 101 is a Central Processing Unit (CPU), a Field Programmable Gate Array (FPGA) or the like, for example. The processor 101 can also be a multiprocessor. Further, the logistics management server 100 may include a processing circuitry. The processing circuitry may be either a single circuit or a combined circuit.

The volatile storage device 102 is main storage of the logistics management server 100. The volatile storage device 102 is a Random Access Memory (RAM), for example. The nonvolatile storage device 103 is auxiliary storage of the logistics management server 100. The nonvolatile storage device 103 is a Hard Disk Drive (HDD) or a Solid State Drive (SSD), for example.

The mobile object management server 200 includes a processor, a volatile storage device and a nonvolatile storage device similarly to the logistics management server 100.

Next, functions of the logistics management server 100, the mobile object management server 200, the supply mobile object 300 and the reception mobile object 400 will be described below. First, functions of the mobile object management server 200 will be described below.

FIG. 3 is a block diagram showing the functions of the mobile object management server in the first embodiment. The mobile object management server 200 includes a storage unit 210, a communication unit 220 and a management unit 230.

The storage unit 210 may be implemented as a storage area reserved in the volatile storage device or the nonvolatile storage device included in the mobile object management server 200.

Part or all of the communication unit 220 and the management unit 230 may be implemented by a processing circuitry included in the mobile object management server 200. Further, part or all of the communication unit 220 and the management unit 230 may be implemented as modules of a program executed by the processor included in the mobile object management server 200.

The storage unit 210 stores status information regarding the supply mobile object 300 and the reception mobile object 400. For example, the status information regarding the supply mobile object 300 and the reception mobile object 400 includes present positions of the supply mobile object 300 and the reception mobile object 400, remaining fuel amounts of the supply mobile object 300 and the reception mobile object 400, and operational states of the supply mobile object 300 and the reception mobile object 400. For example, the operational state can be a stopped state. The storage unit 210 may also store map information.

The communication unit 220 executes communication with the logistics management server 100, the supply mobile object 300 and the reception mobile object 400. The communication unit 220 receives the control information from the logistics management server 100.

The management unit 230 issues commands based on the control information to the supply mobile object 300 and the reception mobile object 400 via the communication unit 220.

Next, functions of the logistics management server 100 will be described below.

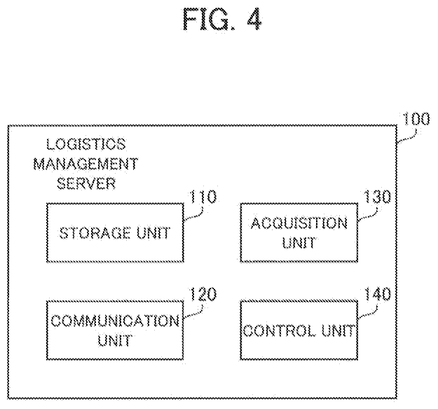

FIG. 4 is a block diagram showing the functions of the logistics management server in the first embodiment. The logistics management server 100 includes a storage unit 110, a communication unit 120, an acquisition unit 130 and a control unit 140.

The storage unit 110 may be implemented as a storage area reserved in the volatile storage device 102 or the nonvolatile storage device 103.

Part or all of the communication unit 120, the acquisition unit 130 and the control unit 140 may be implemented by the processing circuitry. Further, part or all of the communication unit 120, the acquisition unit 130 and the control unit 140 may be implemented as modules of a program executed by the processor 101. For example, the program executed by the processor 101 is referred to also as a control program. The control program has been recorded in a record medium, for example.

The storage unit 110 may store the map information, position information on the supply mobile object 300, position information on the reception mobile object 400, and delivery position information. The position information on the supply mobile object 300 is information indicating the present position of the supply mobile object 300. The position information on the reception mobile object 400 is information indicating the present position of the reception mobile object 400. The delivery position information is information indicating at least one of delivery source position information regarding a parcel and delivery destination position information regarding a parcel. Incidentally, the delivery source position information is information indicating the position of the delivery source of the parcel. The delivery destination position information is information indicating the position of the delivery destination of the parcel. The delivery position information is included in the delivery request.

The communication unit 120 executes communication with the mobile object management server 200 and the terminal device 500. Further, the communication unit 120 may execute communication with the supply mobile object 300 and the reception mobile object 400.

The acquisition unit 130 acquires the map information, the position information on the supply mobile object 300, the position information on the reception mobile object 400, and the delivery position information. For example, the acquisition unit 130 acquires the map information, the position information on the supply mobile object 300, the position information on the reception mobile object 400, and the delivery position information from the storage unit 110. Alternatively, for example, the acquisition unit 130 acquires the map information, the position information on the supply mobile object 300, the position information on the reception mobile object 400, and the delivery position information from the mobile object management server 200 via the communication unit 120. Further, the acquisition unit 130 may acquire the map information, the position information on the supply mobile object 300, the position information on the reception mobile object 400, and the delivery position information from a different device via the communication unit 120.

The control unit 140 generates a plurality of route graphs including a plurality of refueling scheduled positions based on the map information, the position information on the supply mobile object 300, the position information on the reception mobile object 400, and the delivery position information. Here, an example of the plurality of route graphs will be shown below.

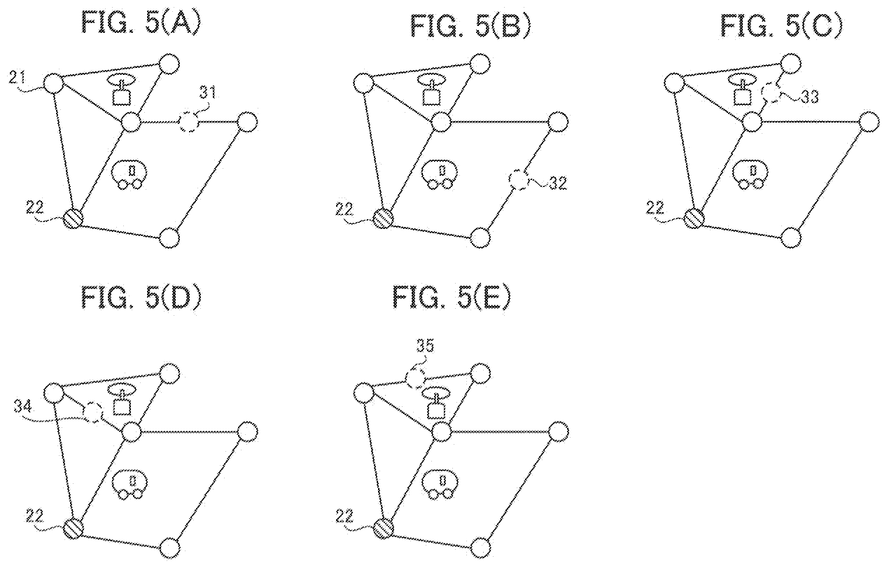

FIGS. 5(A) to 5(E) are diagrams showing an example of the plurality of route graphs in the first embodiment. FIGS. 5(A) to 5(E) show examples of the route graph.

An open circle in each of FIGS. 5(A) to 5(E) can represent the delivery source position indicated by the delivery source position information. An open circle in each of FIGS. 5(A) to 5(E) can represent the delivery destination position indicated by the delivery destination position information. One open circle in each of FIGS. 5(A) to 5(E) can represent the present position of the supply mobile object 300 indicated by the position information on the supply mobile object 300. One open circle in each of FIGS. 5(A) to 5(E) can represent the present position of the reception mobile object 400 indicated by the position information on the reception mobile object 400. For example, the open circle 21 in FIG. 5(A) represents the delivery destination position.

Further, each of the present position of the supply mobile object 300 and the present position of the reception mobile object 400 can also be situated on a line.

The refueling scheduled position is set in each of the plurality of route graphs. FIGS. 5(A) to 5(E) respectively indicate refueling scheduled positions 31 to 35. The control unit 140 sets the refueling scheduled position on a route between an open circle and an open circle. Further, when the length of a route between an open circle and an open circle is less than or equal to a predetermined threshold value, the control unit 140 does no set the refueling scheduled position on the route.

Furthermore, when setting the refueling scheduled position in each of the plurality of route graphs, the control unit 140 sets the refueling scheduled position on a line other than a line connecting the position of a refueling station indicated by the map information and the position indicated by the delivery source position information, the position indicated by the delivery destination position information, the position indicated by the position information on the supply mobile object 300 or the position indicated by the position information on the reception mobile object 400. Simply put, when a refueling station exists in the vicinity of an open circle, the control unit 140 does not set the refueling scheduled position in the vicinity of the refueling station. For example, the map information is assumed to include a refueling station 22. When the refueling station 22 exists in the vicinity of an open circle, the control unit 140 does not set the refueling scheduled position in the vicinity of the refueling station 22. Specifically, the control unit 140 does not set the refueling scheduled position on a line connected to the refueling station 22. Incidentally, in cases where the fuel is gasoline, for example, the refueling station 22 is a gas station. In cases where the fuel is hydrogen, the refueling station 22 is a hydrogen station.

Here, as will be described later, control information for making the reception mobile object 400 carry out the delivery is generated based on a route graph. The reception mobile object 400 can refuel if the reception mobile object 400 goes to the refueling station 22. However, when the reception mobile object 400 goes to the refueling station 22, the travel distance of the reception mobile object 400 increases. Therefore, the control unit 140 does not set the refueling scheduled position in the vicinity of the refueling station 22 so as to make the reception mobile object 400 carry out the delivery without going to the refueling station 22. As above, the logistics management server 100 is capable of shortening the travel distance of the reception mobile object 400 by generating the control information based on a route graph in which the refueling scheduled position has not been set in the vicinity of the refueling station 22.

The control unit 140 determines a route graph of a route in which the travel distance of the supply mobile object 300 and the reception mobile object 400 is the shortest out of the plurality of route graphs. Specifically, the control unit 140 determines a route graph of a route in which the travel distance of the supply mobile object 300 and the reception mobile object 400 is the shortest out of the route graphs of FIGS. 5(A) to 5(E). Incidentally, the determined route is a route when the supply mobile object 300 and the reception mobile object 400 execute at least one of delivery of a parcel and pickup of a parcel and the supply mobile object 300 and the reception mobile object 400 stop by the refueling scheduled position. For example, the control unit 140 is capable of determining one route graph by solving a problem like the traveling salesman problem (TSP). Then, the control unit 140 determines the route graph of FIG. 5(A), for example. Incidentally, the refueling scheduled position 31 turns into a refueling position.

It is also possible for the control unit 140 to determine a route graph of a route in which the travel distance of the supply mobile object 300 and the reception mobile object 400 is less than or equal to a predetermined threshold value.

Further, it is also possible for the control unit 140 to determine a route graph of a route determined based on an ordinal rank corresponding to the travel distance of the supply mobile object 300 and the reception mobile object 400. The determination process will be described in detail below. The control unit 140 assigns an ordinal rank to the travel distance regarding each of a plurality of routes corresponding to the plurality of route graphs. Specifically, the ordinal ranks are assigned in ascending order of the travel distance. Accordingly, the ordinal ranks are assigned to the travel distances. The control unit 140 determines one route based on the ordinal rank corresponding to the travel distance. For example, the control unit 140 determines one route out of routes of top three ranked travel distances. Then, the control unit 140 determines the route graph of the determined route. As above, the control unit 140 may determine the route graph based on the ranking of the travel distance.

The control unit 140 generates the control information, as information for controlling the supply mobile object 300 and the reception mobile object 400, based on the determined route graph. This sentence may also be expressed as follows. The control unit 140 generates the control information, including information regarding at least one of delivery and pickup and being information for controlling the supply mobile object 300 and the reception mobile object 400 traveling in the route indicated by the determined route graph, based on the determined route graph. Here, an example of the control information will be shown below.

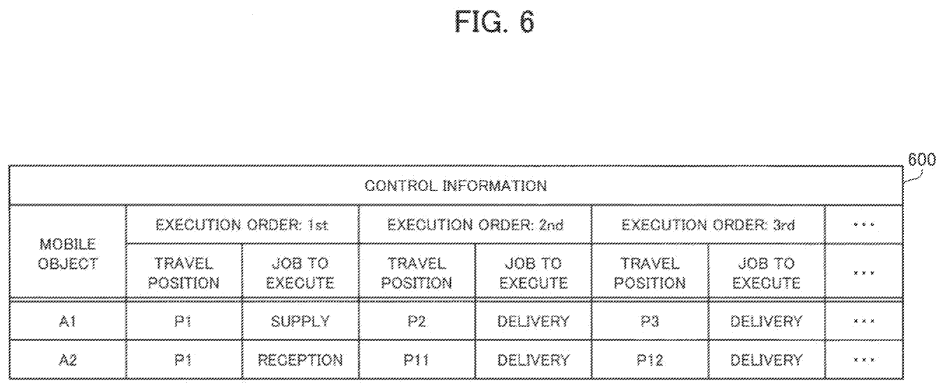

FIG. 6 is a diagram showing an example of the control information in the first embodiment. The control information 600 may be referred to also as a delivery plan. The control information 600 has items of mobile object and execution order.

In the item of mobile object, a name or an identifier of each mobile object is registered. For example, the mobile object “A1” is the identifier of the supply mobile object 300. Further, for example, the mobile object “A2” is the identifier of the reception mobile object 400.

Each item of execution order includes items of travel position and job to execute. In the item of travel position, a position to which the supply mobile object 300 or the reception mobile object 400 should be made to travel is registered. In the item of job to execute, a job that the supply mobile object 300 or the reception mobile object 400 should be made to execute is registered.

As shown in FIG. 6, the control information 600 includes information regarding at least one of delivery and pickup and information regarding the refueling.

After the control information 600 is generated, the communication unit 120 transmits the control information 600 to the mobile object management server 200.

Next, functions of the supply mobile object 300 and the reception mobile object 400 will be described below. Here, the functions of the supply mobile object 300 and the functions of the reception mobile object 400 are substantially the same as each other. Thus, the functions of the supply mobile object 300 will be described below. Then, the description of the functions of the reception mobile object 400 will be left out.

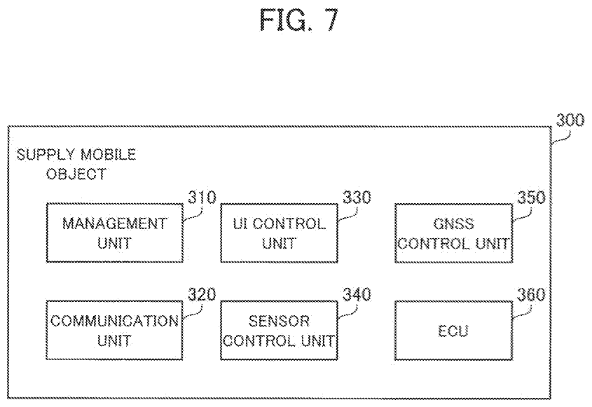

FIG. 7 is an example of a block diagram showing the functions of the supply mobile object in the first embodiment. The supply mobile object 300 includes a management unit 310, a communication unit 320, a User Interface (UI) control unit 330, a sensor control unit 340, a Global Navigation Satellite System (GNSS) control unit 350 and an Engine Control Unit (ECU) 360.

The management unit 310 manages the remaining fuel amount of the supply mobile object 300. The communication unit 320 executes communication with the mobile object management server 200. The communication unit 320 periodically transmits the status information to the mobile object management server 200. The UI control unit 330 provides a user with the UI. The sensor control unit 340 acquires information from a camera, a radar or the like and executes control based on the information. The GNSS control unit 350 acquires the present position of the supply mobile object 300. Incidentally, the position information indicating the present position is included in the status information. The ECU 360 controls a motor, steering, and so forth.

Next, a process executed in the control system will be described below by using sequence diagrams.

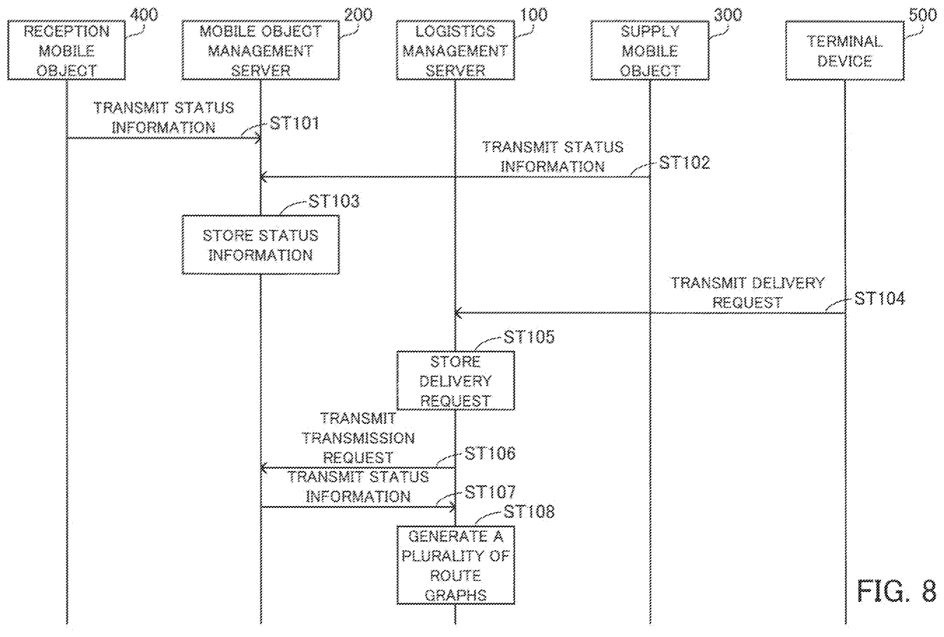

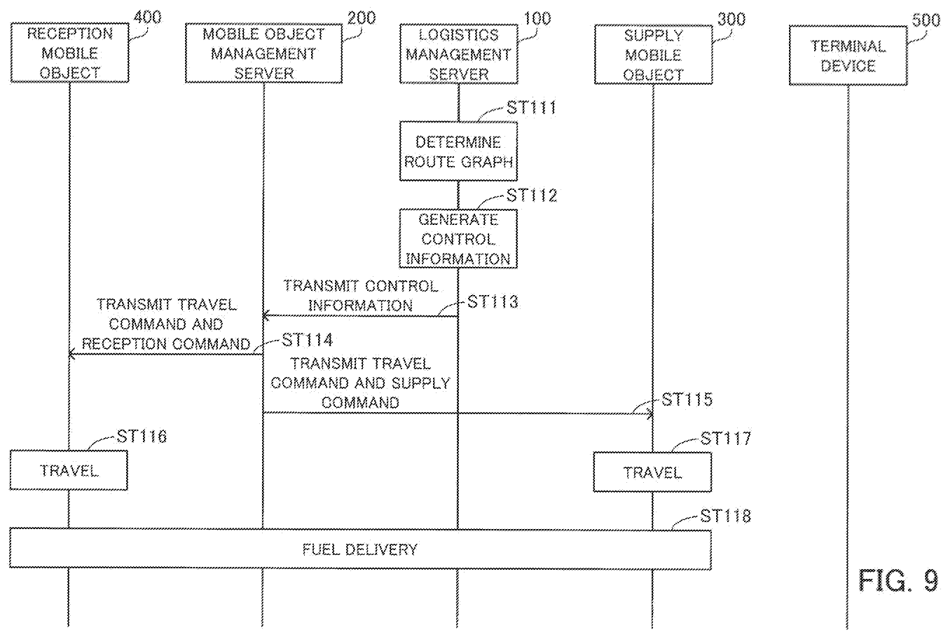

FIG. 8 is a sequence diagram (No. 1) showing an example of the process executed in the control system in the first embodiment.

(Step ST101) The reception mobile object 400 transmits the status information to the mobile object management server 200.

(Step ST102) The supply mobile object 300 transmits the status information to the mobile object management server 200.

(Step ST103) The mobile object management server 200 stores the status information received from the supply mobile object 300 and the status information received from the reception mobile object 400 in the storage unit 210.

(Step ST104) The terminal device 500 transmits the delivery request to the logistics management server 100. Incidentally, the delivery request includes the delivery position information.

(Step ST105) The logistics management server 100 stores the delivery request in the storage unit 110.

(Step ST106) If the latest position information on the supply mobile object 300 and the reception mobile object 400 has not been stored yet, the logistics management server 100 transmits a transmission request for the status information on the supply mobile object 300 and the status information on the reception mobile object 400 to the mobile object management server 200.

(Step ST107) The mobile object management server 200 transmits the status information on the supply mobile object 300 and the status information on the reception mobile object 400 to the logistics management server 100.

Accordingly, the logistics management server 100 receives the latest position information on the supply mobile object 300 and the reception mobile object 400. Here, the supply mobile object 300 and the reception mobile object 400 are assumed to include a parcel. (Step ST108) The logistics management server 100 generates a plurality of route graphs based on the map information, the position information on the supply mobile object 300, the position information on the reception mobile object 400, and the delivery position information.

FIG. 9 is a sequence diagram (No. 2) showing the example of the process executed in the control system in the first embodiment.

(Step ST111) The logistics management server 100 determines a route graph of a route in which the travel distance of the supply mobile object 300 and the reception mobile object 400 is the shortest out of the plurality of route graphs.

(Step ST112) The logistics management server 100 generates the control information 600 based on the determined route graph.

(Step ST113) The logistics management server 100 transmits the control information 600 to the mobile object management server 200.

(Step ST114) The mobile object management server 200 transmits a travel command and a reception command to the reception mobile object 400 based on the control information 600. For example, the mobile object management server 200 transmits the travel command, indicating travel to a travel position “P1”, to the reception mobile object 400. For example, when the reception mobile object 400 operates in autonomous driving and receives the reception command, a setting is made on the reception mobile object 400 to execute a fuel reception process. When the reception mobile object 400 is operated by a driver and receives the reception command, the reception mobile object 400 may display FUEL RECEPTION on its display. Accordingly, the driver recognizes that the fuel reception should be executed.

(Step ST115) The mobile object management server 200 transmits a travel command and a supply command to the supply mobile object 300 based on the control information 600. For example, the mobile object management server 200 transmits the travel command, indicating travel to the travel position “P1”, to the supply mobile object 300. For example, when the supply mobile object 300 operates in autonomous driving and receives the supply command, a setting is made on the supply mobile object 300 to execute a fuel supply process. When the supply mobile object 300 is operated by a driver and receives the supply command, the supply mobile object 300 may display FUEL SUPPLY on its display. Accordingly, the driver recognizes that the fuel supply should be executed.

(Step ST116) The reception mobile object 400 travels according to the travel command. For example, the reception mobile object 400 travels to the travel position “P1”.

(Step ST117) The supply mobile object 300 travels according to the travel command. For example, the supply mobile object 300 travels to the travel position “P1”.

(Step ST118) Fuel delivery is executed.

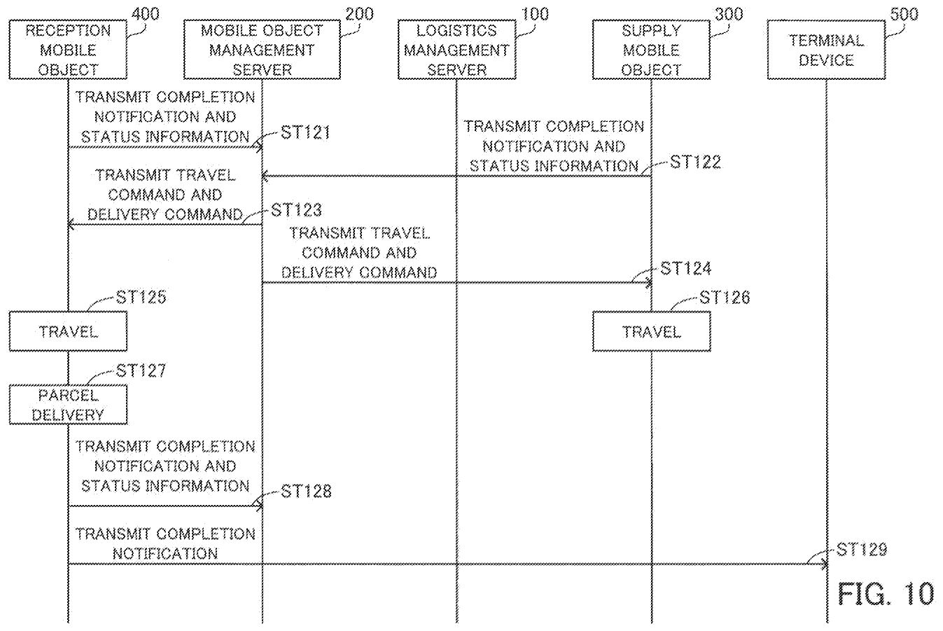

FIG. 10 is a sequence diagram (No. 3) showing the example of the process executed in the control system in the first embodiment.

(Step ST121) The reception mobile object 400 transmits a completion notification and the status information to the mobile object management server 200. Incidentally, the completion notification includes information indicating that the reception mobile object 400 has received the fuel.

(Step ST122) The supply mobile object 300 transmits a completion notification and the status information to the mobile object management server 200. Incidentally, the completion notification includes information indicating that the supply mobile object 300 has supplied the fuel.

(Step ST123) The mobile object management server 200 transmits a travel command and a delivery command to the reception mobile object 400 based on the control information 600. For example, the mobile object management server 200 transmits the travel command indicating travel to a travel position “P2” and the delivery command to the reception mobile object 400.

(Step ST124) The mobile object management server 200 transmits a travel command and a delivery command to the supply mobile object 300 based on the control information 600. For example, the mobile object management server 200 transmits the travel command indicating travel to a travel position “P11” and the delivery command to the supply mobile object 300.

(Step ST125) The reception mobile object 400 travels according to the travel command. For example, the reception mobile object 400 travels to the travel position “P2”.

(Step ST126) The supply mobile object 300 travels according to the travel command. For example, the supply mobile object 300 travels to the travel position “P11”.

(Step ST127) The reception mobile object 400 delivers the parcel. Here, the parcel is the parcel indicated by the delivery request.

(Step ST128) The reception mobile object 400 transmits a completion notification and the status information to the mobile object management server 200. Incidentally, the completion notification includes information indicating that the delivery of the parcel is completed.

(Step ST129) The reception mobile object 400 transmits the completion notification to the terminal device 500.

According to the first embodiment, the logistics management server 100 determines a route graph of a route in which the travel distance of the supply mobile object 300 and the reception mobile object 400 is the shortest out of the plurality of route graphs. It is also possible for the logistics management server 100 to determine a route graph of a route in which the travel distance of the supply mobile object 300 and the reception mobile object 400 is less than or equal to a predetermined threshold value. Further, it is also possible for the logistics management server 100 to determine a route graph of a route determined based on the ordinal rank corresponding to the travel distance of the supply mobile object 300 and the reception mobile object 400. The logistics management server 100 generates the control information 600 based on the determined route graph. The supply mobile object 300 and the reception mobile object 400 are controlled based on the control information 600. Therefore, the travel distance of the supply mobile object 300 and the reception mobile object 400 becomes short. Thus, the logistics management server 100 is capable of shortening the travel distance of the supply mobile object 300 and the reception mobile object 400 by generating the control information 600. Further, the shortening of the travel distance of the supply mobile object 300 and the reception mobile object 400 also shortens a travel time of the supply mobile object 300 and the reception mobile object 400.

The supply mobile object 300 and the reception mobile object 400 may deliver objects other than parcels. For example, such an object can be a tool to be used for repair, a material to be used in the traveling, or the like. The material to be used in the traveling is a cushioning material, for example.

Here, the acquisition unit 130 may acquire fuel amount information as information indicating at least one of the remaining fuel amount of the supply mobile object 300 and the remaining fuel amount of the reception mobile object 400. For example, the acquisition unit 130 acquires the fuel amount information from the storage unit 110. Alternatively, for example, the acquisition unit 130 acquires the fuel amount information from the mobile object management server 200. The control unit 140 may generate the plurality of route graphs based on the fuel amount information, the map information, the position information on the supply mobile object 300, the position information on the reception mobile object 400, and the delivery position information. Then, the control unit 140 determines one route graph out of the plurality of route graphs and generates the control information 600 based on the determined route graph. As above, the logistics management server 100 is capable of generating the control information 600 in consideration of the remaining fuel amounts of the supply mobile object 300 and the reception mobile object 400, for example. For example, when the remaining fuel amount of the reception mobile object 400 is small, the logistics management server 100 generates the control information 600 in which the execution order has been set so as to prioritize the fuel supply to the reception mobile object 400 over the parcel delivery. Accordingly, the supply mobile object 300 can supply the fuel to the reception mobile object 400 before the remaining fuel amount of the reception mobile object 400 drops to zero.

### Second Embodiment

Next, a second embodiment will be described below. In the second embodiment, the description is given mainly of features different from those in the first embodiment. In the second embodiment, the description is omitted for features in common with the first embodiment.

In the first embodiment, the description was given of the case where the fuel is supplied from one supply mobile object to one reception mobile object. In the second embodiment, a description will be given of a case where the fuel is supplied from a plurality of supply mobile objects to one reception mobile object. For example, when the number of supply mobile objects is 2, each of the plurality of supply mobile objects supplies the fuel to the reception mobile object for 50% of the amount of the fuel that should be supplied to the reception mobile object. For example, when the fuel is electricity, the method of supplying the fuel from a plurality of supply mobile objects to the reception mobile object may be referred to also as cooperative charging.

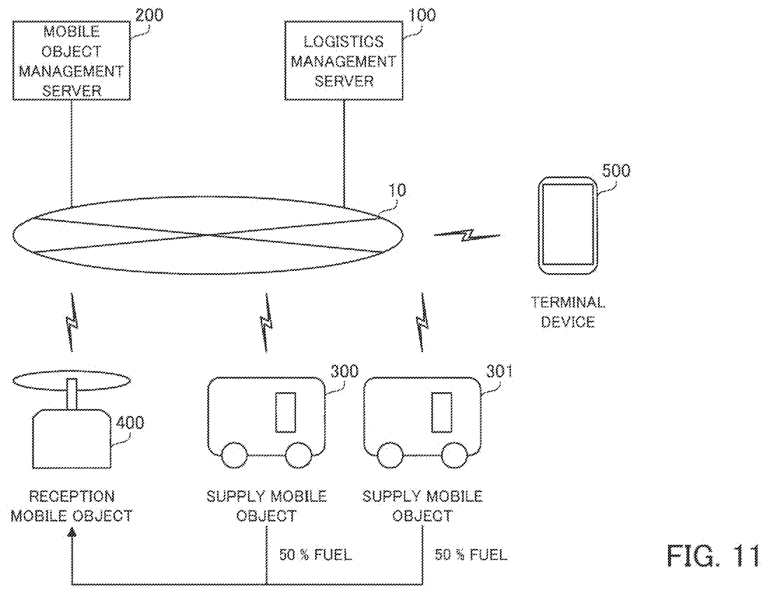

FIG. 11 is a diagram showing a control system in the second embodiment. The control system includes supply mobile objects 300 and 301. FIG. 11 shows two supply mobile objects. The number of supply mobile objects can also be three or more.

The acquisition unit 130 acquires the position information on the supply mobile objects 300 and 301. For example, the acquisition unit 130 acquires the position information on the supply mobile objects 300 and 301 from the storage unit 110.

Alternatively, the acquisition unit 130 acquires the position information on the supply mobile objects 300 and 301 from the mobile object management server 200 via the communication unit 120.

The control unit 140 generates a plurality of route graphs including a plurality of refueling scheduled positions as supply scheduled positions of the fuel supplied by the supply mobile objects 300 and 301 based on the map information, the position information on the supply mobile objects 300 and 301, the position information on the reception mobile object 400, and the delivery position information. Here, an example of the plurality of route graphs will be shown below.

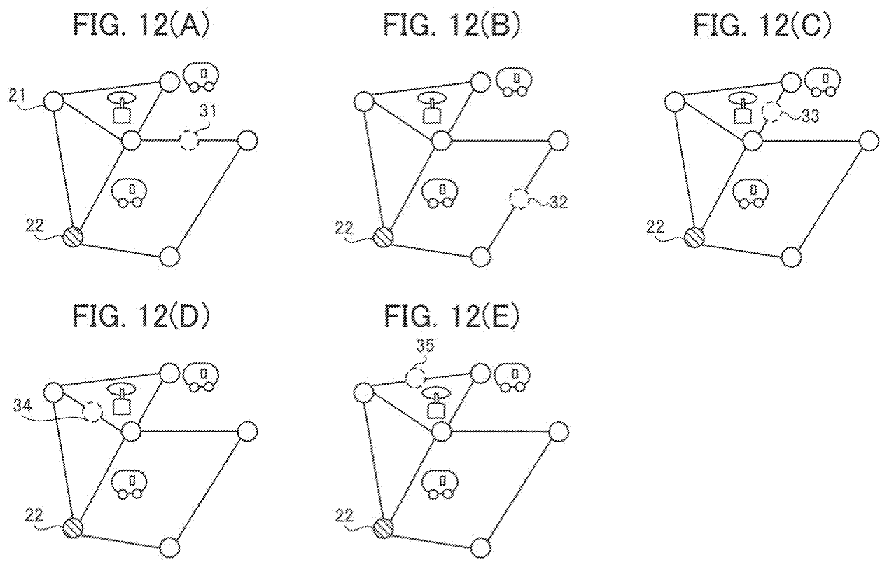

FIGS. 12(A) to 12(E) are diagrams showing an example of the plurality of route graphs in the second embodiment. FIGS. 12(A) to 12(E) show examples of the route graph.

Two open circles in each of FIGS. 12(A) to 12(E) can represent the present positions of the supply mobile objects 300 and 301 indicated by the position information on the supply mobile objects 300 and 301. Further, the present position of each supply mobile object 300, 301 can also be situated on a line.

The method of setting the refueling scheduled position is the same as that in the first embodiment.

The control unit 140 determines a route graph of a route in which the travel distance of the supply mobile objects 300 and 301 and the reception mobile object 400 is the shortest out of the plurality of route graphs. Specifically, the control unit 140 determines a route graph of a route in which the travel distance of the supply mobile objects 300 and 301 and the reception mobile object 400 is the shortest out of the route graphs of FIGS. 12(A) to 12(E). For example, the control unit 140 determines the route graph of FIG. 12(A). Incidentally, the refueling scheduled position 31 turns into the refueling position.

It is also possible for the control unit 140 to determine a route graph of a route in which the travel distance of the supply mobile objects 300 and 301 and the reception mobile object 400 is less than or equal to a predetermined threshold value. Further, it is also possible for the control unit 140 to determine a route graph of a route determined based on the ordinal rank corresponding to the travel distance of the supply mobile objects 300 and 301 and the reception mobile object 400.

The control unit 140 generates the control information, as information for controlling the supply mobile objects 300 and 301 and the reception mobile object 400, based on the determined route graph. An example of the control information will be shown below.

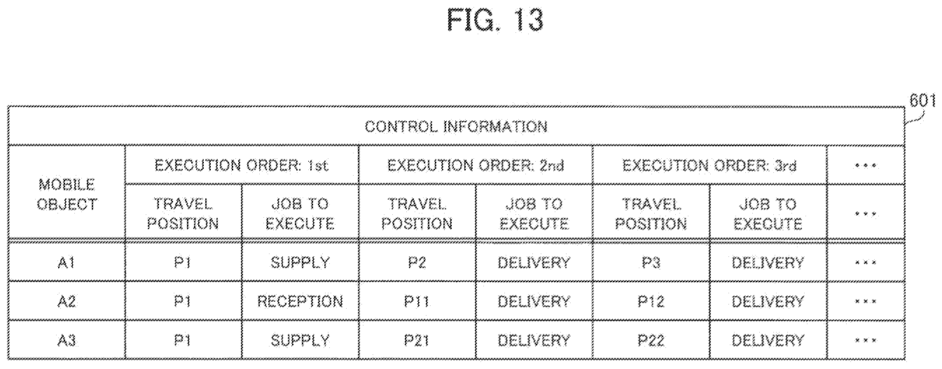

FIG. 13 is a diagram showing an example of the control information in the second embodiment. The control information 601 has items of mobile object and execution order.

In the item of mobile object, the name or the identifier of each mobile object is registered. For example, the mobile object “A3” is the identifier of the supply mobile object 301. The item of execution order is the same as the item of execution order in the control information 600, and thus repeated explanation thereof is left out.

After the control information 601 is generated, the communication unit 120 transmits the control information 601 to the mobile object management server 200.

The mobile object management server 200 controls the supply mobile objects 300 and 301 and the reception mobile object 400 based on the control information 601. Accordingly, the fuel is supplied from the supply mobile objects 300 and 301 to the reception mobile object 400.

According to the second embodiment, the logistics management server 100 is capable of shortening the travel distance of the supply mobile objects 300 and 301 and the reception mobile object 400 by generating the control information 601. Further, the logistics management server 100 is capable of implementing the fuel supply from the supply mobile objects 300 and 301 to the reception mobile object 400.

### Third Embodiment

Next, a third embodiment will be described below. In the third embodiment, the description will be given mainly of features different from those in the first embodiment. In the third embodiment, the description is omitted for features in common with the first embodiment.

In the third embodiment, a description will be given of a case where the supply mobile object 300 supplies the fuel to the reception mobile object 400 when the reception mobile object 400 has shifted to the stopped state due to the depletion of the fuel.

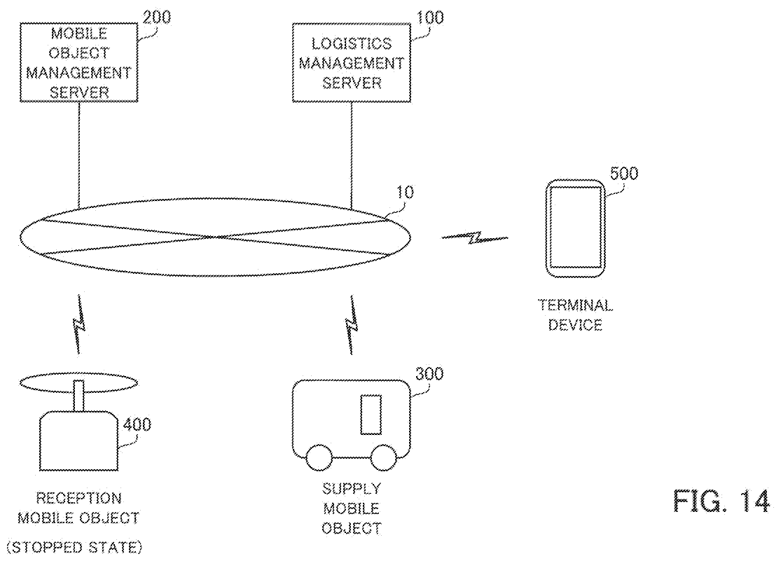

FIG. 14 is a diagram showing a control system in the third embodiment. FIG. 14 indicates that the reception mobile object 400 is in the stopped state.

The acquisition unit 130 acquires stoppage information. For example, the acquisition unit 130 acquires the stoppage information from the storage unit 110. Alternatively, for example, the acquisition unit 130 acquires the stoppage information from the mobile object management server 200. Incidentally, the stoppage information is information indicating that the reception mobile object 400 is in the stopped state.

When the stoppage information is acquired, the control unit 140 generates travel control information based on the map information, the position information on the supply mobile object 300, and the position information on the reception mobile object 400. Incidentally, the position indicated by the position information on the reception mobile object 400 (hereinafter referred to as a reception mobile object position) is the position where the reception mobile object 400 is stopped. Since the reception mobile object 400 periodically transmits the position information (specifically, the status information), the position indicated by the latest position information (i.e., the reception mobile object position) is the position where the reception mobile object 400 is stopped. The travel control information is information for making the supply mobile object 300 travel to the reception mobile object position and supply the fuel to the reception mobile object 400. The communication unit 120 transmits the travel control information to the mobile object management server 200.

The mobile object management server 200 transmits a travel command indicating travel to the reception mobile object position and the supply command to the supply mobile object 300 based on the travel control information. When the supply mobile object 300 is operated by a driver and receives the supply command, the supply mobile object 300 may display FUEL SUPPLY on its display. Accordingly, the driver recognizes that the fuel supply should be executed.

The supply mobile object 300 receives the travel command and accordingly travels to the reception mobile object position. The driver supplies the fuel from the supply mobile object 300 to the reception mobile object 400 stopped at the reception mobile object position. The fuel is supplied to the reception mobile object 400 as above.

According to the third embodiment, the logistics management server 100 is capable of having the fuel supplied to the stopped reception mobile object 400 by generating the travel control information.

### Fourth Embodiment

Next, a fourth embodiment will be described below. In the fourth embodiment, the description will be given mainly of features different from those in the third embodiment. In the fourth embodiment, the description is omitted for features in common with the third embodiment.

In the third embodiment, the description was given of the case where the fuel supply is executed at the reception mobile object position. In the fourth embodiment, a description will be given of a case where the fuel supply is executed while traveling.

When the stoppage information is acquired, the control unit 140 generates the travel control information based on the map information, the position information on the supply mobile object 300, and the position information on the reception mobile object 400.

The travel control information is information for making the supply mobile object 300 travel to the reception mobile object position and then travel from the reception mobile object position to the refueling position indicated by the determined route graph while supplying the fuel to the reception mobile object 400. Here, in the fourth embodiment, when the stoppage information is acquired, the control unit 140 generates the travel control information, and in addition, generates the control information 600 described in the first embodiment. The determined route graph is the route graph used when generating the control information 600. In short, the determined route graph is the route graph determined out of the plurality of route graphs.

The communication unit 120 transmits the travel control information to the mobile object management server 200.

The mobile object management server 200 transmits the travel command indicating travel to the reception mobile object position and the supply command to the supply mobile object 300 based on the travel control information. When the supply mobile object 300 is operated by a driver and receives the supply command, the supply mobile object 300 may display information indicating the traveling while supplying the fuel to the reception mobile object 400 on its display. Accordingly, the driver recognizes that the traveling while supplying the fuel to the reception mobile object 400 should be executed.

The supply mobile object 300 receives the travel command and accordingly travels to the reception mobile object position. Upon arriving at the reception mobile object position, the supply mobile object 300 transmits an arrival notification to the mobile object management server 200. The mobile object management server 200 transmits a travel command indicating travel from the reception mobile object position to the refueling position to the supply mobile object 300 based on the travel control information. The supply mobile object 300 receives the travel command and accordingly travels to the refueling position while supplying the fuel to the reception mobile object 400. Then, upon arriving at the refueling position, the supply mobile object 300 transmits an arrival notification to the mobile object management server 200. The mobile object management server 200 issues commands to the supply mobile object 300 and the reception mobile object 400 based on the control information 600.

As above, the supply mobile object 300 and the reception mobile object 400 travel to the refueling position. The travel of the supply mobile object 300 and the reception mobile object 400 to the refueling position enables the mobile object management server 200 to carry out the control based on the control information 600. The control based on the control information 600 is capable of shortening the travel distance of the supply mobile object 300 and the reception mobile object 400. Thus, according to the fourth embodiment, the logistics management server 100 generating the travel control information for making the supply mobile object 300 and the reception mobile object 400 travel to the refueling position is capable of shortening the travel distance of the supply mobile object 300 and the reception mobile object 400.

In the first to fourth embodiments, the description was given of cases where there exist the logistics management server 100 and the mobile object management server 200. The logistics management server 100 may also have the functions of the mobile object management server 200. In such cases where the logistics management server 100 has the functions of the mobile object management server 200, no mobile object management server 200 exists in the control system.

In the first to fourth embodiments, the description was given of cases where the mobile object management server 200 issues commands to the supply mobile object 300 and the reception mobile object 400. It is also possible for the logistics management server 100 (specifically, the control unit 140) to issue commands to the supply mobile object 300 and the reception mobile object 400 without transmitting the control information 600 or the control information 601 to the mobile object management server 200. Further, it is also possible for the logistics management server 100 (specifically, the control unit 140) to issue commands to the supply mobile object 300 without transmitting the travel control information to the mobile object management server 200.

Features in the embodiments described above can be appropriately combined with each other.

### DESCRIPTION OF REFERENCE CHARACTERS

10: network, 21: open circle, 22: refueling station, 31-35: refueling scheduled position, 100: logistics management server, 101: processor, 102: volatile storage device, 103: nonvolatile storage device, 110: storage unit, 120: communication unit, 130: acquisition unit, 140: control unit, 200: mobile object management server, 210: storage unit, 220: communication unit, 230: management unit, 300, 301: supply mobile object, 310: management unit, 320: communication unit, 330: UI control unit, 340: sensor control unit, 350: GNSS control unit, 400: reception mobile object, 500: terminal device, 600: control information, 601: control information

What is claimed is:

1. An information processing device comprising:
acquiring circuitry to acquire map information, position information on a supply mobile object as a mobile object that supplies fuel, position information on a reception mobile object as a mobile object that receives the fuel, and delivery position information as information indicating at least one of delivery source position information regarding a parcel and delivery destination position information regarding a parcel; and
controlling circuitry to generate a plurality of route graphs including a plurality of refueling scheduled positions based on the map information, the position information on the supply mobile object, the position information on the reception mobile object, and the delivery position information, determine a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance, out of the plurality of route graphs, and generate control information, as information for controlling the supply mobile object and the reception mobile object, based on the determined route graph.

2. The information processing device according to claim 1, wherein
the acquiring circuitry acquires fuel amount information as information indicating at least one of a remaining fuel amount of the supply mobile object and a remaining fuel amount of the reception mobile object, and
the controlling circuitry generates the plurality of route graphs based on the fuel amount information, the map information, the position information on the supply mobile object, the position information on the reception mobile object, and the delivery position information.

3. The information processing device according to claim 1, wherein
the acquiring circuitry acquires the position information on a plurality of supply mobile objects, and
the controlling circuitry generates a plurality of route graphs including a plurality of refueling scheduled positions as supply scheduled positions of the fuel supplied by the plurality of supply mobile objects based on the map information, the position information on the plurality of supply mobile objects, the position information on the reception mobile object, and the delivery position information and determines a route graph of a route in which the travel distance of the plurality of supply mobile objects and the reception mobile object is the shortest, a route graph of a route in which the travel distance is less than or equal to a predetermined threshold value, or a route graph of a route determined based on the ordinal rank corresponding to the travel distance out of the plurality of route graphs.

4. The information processing device according to claim 1, wherein
the acquiring circuitry acquires stoppage information indicating that the reception mobile object is in a stopped state, and
when the stoppage information is acquired, the controlling circuitry generates travel control information, as information for making the supply mobile object travel to a reception mobile object position as a position indicated by the position information on the reception mobile object and supply the fuel to the reception mobile object, based on the map information, the position information on the supply mobile object, and the position information on the reception mobile object.

5. The information processing device according to claim 4, wherein the travel control information is information for making the supply mobile object travel to the reception mobile object position and then travel from the reception mobile object position to a refueling position indicated by the determined route graph while supplying the fuel to the reception mobile object.

6. The information processing device according to claim 1, wherein when setting the refueling scheduled position in each of the plurality of route graphs, the controlling circuitry sets the refueling scheduled position on a line other than a line connecting a position of a refueling station indicated by the map information and a position indicated by the delivery source position information, a position indicated by the delivery destination position information, a position indicated by the position information on the supply mobile object or a position indicated by the position information on the reception mobile object.

7. A control system comprising:
a supply mobile object as a mobile object that supplies fuel;
a reception mobile object as a mobile object that receives the fuel; and
an information processing device,
wherein the information processing device includes:
acquiring circuitry to acquire map information, position information on the supply mobile object, position information on the reception mobile object, and delivery position information as information indicating at least one of delivery source position information regarding a parcel and delivery destination position information regarding a parcel; and
controlling circuitry to generate a plurality of route graphs including a plurality of refueling scheduled positions based on the map information, the position information on the supply mobile object, the position information on the reception mobile object, and the delivery position information, determine a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance, out of the plurality of route graphs, and generate control information, as information for controlling the supply mobile object and the reception mobile object, based on the determined route graph.

8. A control method performed by an information processing device, the control method comprising:
acquiring map information, position information on a supply mobile object as a mobile object that supplies fuel, position information on a reception mobile object as a mobile object that receives the fuel, and delivery position information as information indicating at least one of delivery source position information regarding a parcel and delivery destination position information regarding a parcel;
generating a plurality of route graphs including a plurality of refueling scheduled positions based on the map information, the position information on the supply mobile object, the position information on the reception mobile object, and the delivery position information;
determining a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance, out of the plurality of route graphs; and
generating control information, as information for controlling the supply mobile object and the reception mobile object, based on the determined route graph.

9. An information processing device comprising:
a processor to execute a program; and
a memory to store the program which, when executed by the processor, performs processes of,
acquiring map information, position information on a supply mobile object as a mobile object that supplies fuel, position information on a reception mobile object as a mobile object that receives the fuel, and delivery position information as information indicating at least one of delivery source position information regarding a parcel and delivery destination position information regarding a parcel,
generating a plurality of route graphs including a plurality of refueling scheduled positions based on the map information, the position information on the supply mobile object, the position information on the reception mobile object, and the delivery position information,
determining a route graph of a route in which a travel distance of the supply mobile object and the reception mobile object is the shortest, a route graph of a route in which the travel distance is less than or equal to a predetermined threshold value, or a route graph of a route determined based on an ordinal rank corresponding to the travel distance, out of the plurality of route graphs, and
generating control information, as information for controlling the supply mobile object and the reception mobile object, based on the determined route graph.
